(19) United States
(12) Patent Application Publication
(10) Pub. No.: US 2006/0041932 A1
(43) Pub. Date: Feb. 23, 2006

(54) Systems and methods for recovering passwords and password-protected data

(75) Inventors: Daryl Carvis Cromer, Apex, NC (US); Richard W. Cheston, Morrisville, NC (US); Steven Dale Goodman, Raleigh, NC (US); Howard Jeffrey Locker, Cary, NC (US); Randall Scott Springfield, Chapel Hill, NC (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/924,103

(22) Filed: Aug. 23, 2004

(51) Int. Cl. H04L 9/32

(52) U.S. Cl. 726/6

(57) ABSTRACT

Systems and methods to access password-protected stored data when a corresponding data password has been lost, forgotten, or is otherwise unavailable, and to recover the data password to facilitate access to the password-protected data from a digital memory device such as a hard disk drive associated with a user computer. In some embodiments the computer is communicatively coupled with a network and receives at least one encryption key from a secure computer via the network. In other embodiments the computer is a stand alone computer and receives at least one encryption key from a removable, non-volatile memory such as a CD ROM. The encryption key is used to encrypt the data password and both are stored on the hard disk drive. If the data password becomes lost, forgotten, or otherwise unavailable, the encrypted password is recovered from the hard disk drive and decrypted to recover the data password.

### FIELD OF INVENTION

The present invention is in the field of computer systems. More particularly, the present invention relates to systems and methods to access password-protected data when a corresponding data password has been lost, forgotten, or is otherwise unavailable, and to recover the data password to facilitate recovery of the password-protected data from a digital memory device such as a hard disk drive.

### BACKGROUND

Many different types of computing systems have attained widespread use around the world. These computing systems (computers) include personal computers, servers, mainframes and a wide variety of stand alone and embedded computing devices. For example, personal computer systems are well known in the art. Personal computers (PCs) may be defined as a desktop, floor standing, or portable microcomputer that includes a system unit having a central processing unit (CPU) and associated volatile and non-volatile memory, including random access memory (RAM) and basic input/output system read only memory (BIOS ROM), a system monitor, a keyboard, one or more removable non-volatile media drives such as a diskette drive, compact disk read-only memory (CD ROM) drive or digital versatile disc or digital video disk (DVD) drive, a fixed disk storage drive also known as a “hard drive” or “HDD”, a pointing device such as a mouse, and an optional network interface adapter. One of the distinguishing characteristics of these systems is the use of a motherboard or system planar or backplane to communicatively couple these components together. Examples of such personal computer systems are IBM's ThinkCentre series, ThinkPad series, and Intellistation series.

Computers are used for business, government and personal reasons. Large markets exist to service business, government and personal computer segments by creating and distributing seemingly ever more powerful, versatile and cost-effective computers. Constantly increasing computer power has in turn supported a huge increase over time in the types of software applications available. Software applications commonly perform word processing, spreadsheet, accounting, e-mail, voice over Internet protocol telecommunications, facsimile, and a growing list of simulation, modeling, analysis and tracking functions. For example, businesses often employ a wide variety of computing applications to support critical work activities such as accounting, customer support, engineering and sales. Government entities often use computers to track statistical and project data. Individuals and families often use computers for word processing, homework, research, telecommuting, games, news, stock market information and trading, banking, shopping, shipping, communication in the form of Voice over Internet protocol (VoIP) and email, as well as many other activities. In fact, for many business and personal owners, PCs represent an essential tool for their livelihood.

Corresponding to their variety of uses and users, computers are physically located in wide variety of locations from the physically secure to the home office to airplane and train terminals. Mobile PCs such as laptop computers are designed to be transported over distances, including away from available power supplies, so at any given time they can be in unsecured areas. For this and other reasons, the loss or theft of computers is an all too frequent occurrence.

Because of the utility and widespread use of computers, one of the prominent features of computers is the creation, storage and use of digital data. The vast majority of computer programs create, store and use digital data as part of their functioning. The nature of this data can be fairly trivial, say related to a video game, or alternatively the data can be essential trade secret business information whose value to its owner far outweighs the value of the computer that contains it. Many computers store most of their non-volatile data as hardfiles on hard disk drives (HDDs). For example, business computers, including laptop computers in particular, often contain valuable data stored on HDDs and are transported to many different locations outside of the more secure confines of the business environment. In this manner, valuable and confidential data can be carried in computers to unsecured areas where they are more likely to be lost or stolen. For this reason and others, computers have been created with the capability to password-protect HDD data. Thus, for example, if a computer is stolen, or if an unauthorized individual tries to access the computer, the HDD data will remain secure as long as the data password remains confidential.

Currently, many software applications offer password protection, leading to many users being responsible for a large and increasing number of passwords. As the number of software applications and their associated passwords proliferate, so does the difficulty for the users to keep track of all those passwords, including those associated with data stored in hardfiles on HDDs. On one hand, to manage those passwords some users select the same password, or a small set of passwords that may be discovered or are easily guessed at by unauthorized persons desirous of the data in such a computer. This particular user behavior minimizes the effectiveness of password protection schemes because it increases the likelihood that the password discovered in one context will be used by an unauthorized person in not only that context and but also in many others. On the other hand, some individuals select a variety of more difficult-to-guess passwords, preserving the integrity of the password protection, but this has a down-side as well.

Unfortunately, it is often the case that the most obscure and therefore secure passwords are the most difficult to remember. Furthermore, even simple passwords can be forgotten through infrequent use. Occasionally users can maliciously set passwords and fail to release corresponding password protected data which in actuality is owned by another, such as a recent former employer. In all these cases and many others where the password associated with password protected data is not available to the data's owner or a legitimate user, the underlying password-protected data is irretrievably lost. The loss of such password-protected data can have a significant, negative impact on the owner or user of that data. For example, original business data accumulated at considerable expense that becomes lost may require a second expenditure of funds and efforts to recreate that data. For this reason, computer owners such as businesses often avoid password protection of data, especially hard disk drive data, to avoid costly losses, thereby defeating the entire password-protection scheme for HDDs and other storage devices.

There is, therefore, a need for owners and authorized users of computers to recover their password-protected data, when the password protecting that data is lost, forgotten or otherwise becomes unavailable, and the corresponding password-protected data would otherwise be inaccessible.

### SUMMARY OF THE INVENTION

The problems identified above and other problems associated with forgotten, lost or otherwise unavailable passwords, are in large part addressed by systems and methods of the present invention to access password-protected stored data when the corresponding password has become lost, forgotten, or otherwise unavailable, and to recover the data password to facilitate recovery of the password-protected data from a digital memory device such as a hard disk drive.

Some embodiments of the present invention provide methods for recovering a data password used to password-protect data stored in a data storage device such as a hard disk drive. The data password is encrypted to form an encrypted password. Both the data password and the encrypted password are stored on the storage device. When a need arises to recover the data password, the encrypted password is retrieved from the data storage device by a program, e.g. BIOS. The decryption key is used to decrypt the password on another computer such as a secure computer coupled with the user computer via a computer network or by the user computer to derive the data password.

Some embodiments of the present invention provide methods for recovering a data password used to password-protect data stored in a hard disk drive communicatively coupled with a user computer. The user computer receives both a data password, e.g., from an authorized person using the computer (user), and an encryption key. The encryption key is stored in a limited-access, non-volatile memory in the user computer such as a trusted platform module (TPM). The encryption key is used to encrypt the data password, both of which are stored on the hard disk drive. When the data password becomes lost, forgotten or otherwise unavailable, the user computer retrieves the encrypted password from the hard disk drive and initiates decryption of the encrypted password to derive the data password. The decryption can occur in the user computer or in another computer. The previously lost, forgotten or unavailable data password can then be used to access the password-protected data.

Some embodiments of the present invention provide an apparatus to recover a data password used to password-protect data stored in a data storage device such as a hard disk drive. An encryption module encrypts the data password to form an encrypted password. A recovery module stores the encrypted password on the hard disk drive and later retrieves the encrypted password from the hard disk drive and transmits the encrypted password to a decryption module. The decryption module decrypts the encrypted password with one or more decryption keys to derive the data password.

Some embodiments of the present invention provide computer-readable media for implementing methods for recovering a data password used to password-protect data stored in a hard disk drive communicatively coupled with a computer. The computer-readable media provides an encryption key to a user computer so that the user computer can encrypt a data password for storage on a hard disk drive. The computer-readable media also provides the decryption key to the user computer to decrypt the data password when prompted by the user.

Some embodiments contemplate a limited-access, non-volatile memory resident in a user computer to store at least one encryption key generally unknown to computer users, e.g., an encryption key specified by the user computer's manufacturer or vendor. The encryption key is used to encrypt a data password selected by the user. Both the password and the encrypted password are stored on a storage device such as a hard disk drive. If the user's data password becomes unavailable, the user initiates a data recovery software application through a request for assistance or running of the data recovery software application. The data recovery software application can reside in another computer such as a secure computer or within the user computer. The encrypted password is recovered from the storage device, for example, with a known Identify Device command issued from the BIOS, causing the encrypted password to be returned from the storage device. The encrypted password is then decrypted with the decryption key by the user computer or another computer.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an overview of one embodiment of a system having a computer network to access password-protected data stored on a hard disk drive (HDD) of a user's computer;

FIG. 2 depicts an overview of an alternative embodiment of a system having a removable storage media such as compact disk read-only memory (CD ROM) to access password-protected data stored on a hard disk drive (HDD) of a user's computer;

FIG. 3 depicts a block diagram showing a password recovery apparatus including an encryption module, a recovery module and a decryption module;

FIG. 4 depicts a flow chart for the generation and storage of an encryption key;

FIG. 5 depicts a flow chart for the creation and storage of a data password and an encrypted password on a HDD;

FIG. 6 depicts a flow chart for accessing an encrypted password; and

FIG. 7 depicts a flow chart for decrypting the encrypted password to recover the data password to facilitate recover of corresponding password-protected data in user computers such as the computers illustrated in FIG. 1 and FIG. 2.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The written and detailed descriptions herein are designed to enable one of ordinary skill in the art to practice such embodiments.

Generally speaking, systems and methods for securely accessing password-protected data without the password are contemplated. Embodiments employ at least one encryption method such as the use of an encryption key to encrypt the user selected password. In some embodiments described herein, multiple keys are generated and used. In some embodiments a user computer is provided with an encryption key through a computer network, such as one internal to a corporation's information technology (IT) department, the Internet, an intranet, an extranet, etc., with a copy of the encryption key stored on a separate computer or on a removable, non-volatile storage media. In other embodiments the user computer receives the encryption key loaded into the user computer by the computer manufacturer, computer vendor or corporate IT personnel with a copy of the encryption and decryption keys stored on a separate computer or a compact disk read-only memory (CD ROM) or other removable and non-volatile media. Note that the embodiments are not limited to a CD ROM, in fact the present invention also contemplates substitution of the CD ROM and drive with any removable, non-volatile memory and drive, including digital versatile disk read-only memory also known as digital video disk read-only memory (DVD ROM), etc. In still other embodiments the user computer receives the encryption key on a CD ROM to be loaded into the user computer in conjunction with the user's password selection to implement this method on the user's computer.

In many embodiments, the encryption key is stored in secure, non-volatile memory, such as a trusted platform module (TPM), accessible only to the user computer's basic input-output system (BIOS) code, which is modified to implement embodiments of the present invention. At the prompting of known password-setting HDD software running on the user's computer, the user creates a password for the HDD data associated with one or more hardfiles stored on the computer's hard disk drive (HDD). In accordance with some embodiments of the present invention, a modified BIOS transmits the password to a non-volatile storage in the user computer, such as a TPM, which stores the encryption key and uses the encryption key to encrypt the password, then transmits the encrypted password back to the BIOS. The BIOS then stores both the unaltered data password and the encrypted password onto the HDD. The encrypted password is stored in separate location from the data password which is accessible to software running on the computer, e.g., BIOS, via a hardfile command such as the Identify Device command. In normal operation the user's computer prompts the user for their data password in order to compare against the HDD-stored data password to authenticate the user and provide authenticated access to the corresponding password-protected data. In normal operation, if the password becomes lost, forgotten, or is otherwise unavailable, the password-protected data would likewise become irretrievably lost. However, in embodiments of the present invention, if the password becomes lost, forgotten, or is otherwise unavailable, a password recovery program is initiated. The password recovery program retrieves the encrypted password from the HDD, e.g., with an Identify Device Command. The encrypted password is decrypted by the possessor of the decryption key and provided to the user. The user can then access the password-protected data with the password as before and no data is lost, a significant improvement of the prior art in which all data would be lost.

While specific embodiments will be described herein with reference to particular configurations of computers, HDDs and non-volatile memory, those of skill in the art will realize that embodiments of the present invention may advantageously be implemented with other substantially equivalent circuit configurations and elements.

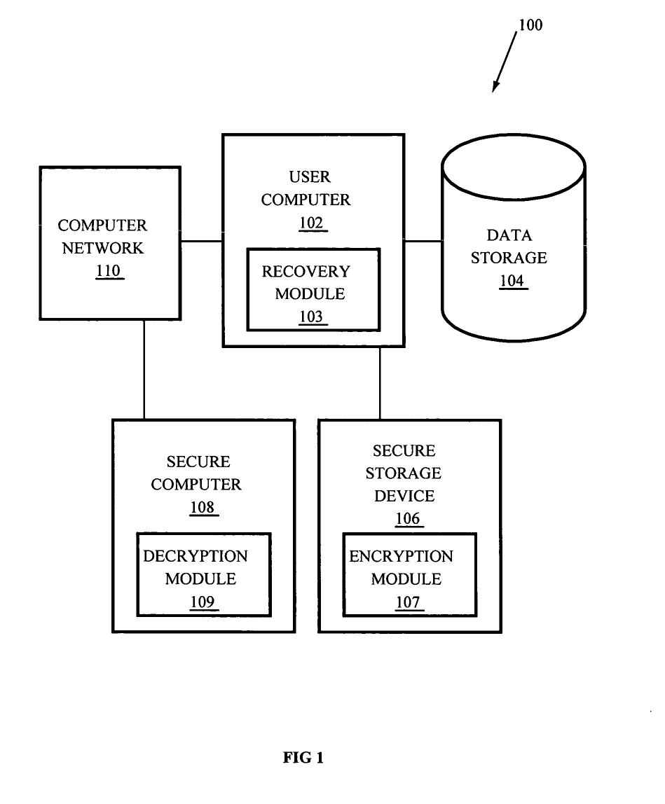

Turning to the drawings, FIG. 1 depicts one embodiment of a password and data recovery system 100 having a user computer 102. The user computer 102 can be a laptop computer, desktop personal computer, a server, or any other kind of computing device having a central processing unit (CPU) and a digital communications capability or removable non-volatile storage media such as a CD ROM. The user computer 102 includes a password recovery software module (recovery module) 103. In some embodiments, the recovery module 103 is communicatively coupled with, or functionally combined with, a basic input/output system (BIOS) program running on the user computer 102.

The user computer 102 is communicatively coupled with a data storage device (data storage) 104 for mass, non-volatile, data storage. In many embodiments the recovery module 103 in the user computer 102 is also communicatively coupled with data storage 104 for storing and retrieving encrypted passwords, as described below. The recovery module 103 facilitates recovery of a data password associated with password-protected data stored in the data storage 104 that has become lost, forgotten or otherwise unavailable. In several embodiments, data storage 104 is a hard disk drive (HDD). The HDD 104 can be integrated into the physical housing of the user computer 102 such as with many currently-available laptop and desktop computers, but this is not required. Furthermore, the embodiments are not limited to HDDs, but will function with any data storage device employed with the user computer 102 that is capable of storing password-protected data.

The recovery module 103 in the user computer 102 is communicatively coupled with a non-volatile, secure, storage device (secure storage device) 106. In some embodiments the secure storage device 106 is a trusted platform module (TPM), however, any non-volatile storage apparatus will also suffice. For example, Flash memory or electrically erasable programmable read-only memory (EEPROM) can also be used to implement the secure storage device 106. In many embodiments, the secure storage device 106 contains an encryption module 107. The embodiments are not limited to any particular type of encryption. With at least one encryption key, the encryption module 107 encrypts the data password to form an encrypted password. The encryption module 107 transmits the encrypted password to the recovery module 103 for storage in the data storage 104 as described below.

In some embodiments, the secure storage device 106 receives the encryption key from a secure computer 108 via a computer network 110. In other embodiments, the secure storage device 106 receives the encryption key more directly from a secure computer 108 maintained by a manufacturer of the user computer 102, a vendor of the user computer 102, corporate IT personnel, or others, without the use of a separate computer network 110. In further embodiments, the computer network 110 includes a Preboot eXecution Environment (PXE) capability such as that offered by Intel Corporation, Santa Clara, Calif., but PXE is not required.

The secure computer 108 contains a decryption module 109 for decrypting the encrypted password to derive the data password. The recovery module 103 retrieves the encrypted password from data storage 104 and transmits the encrypted password to the decryption module 109 in the secure computer 108. The decryption module 109 has access to a copy of the encryption key used by the encryption module 107 to encrypt the data password as well as the decryption key to be used to decrypt the encrypted password (in some embodiments, the encryption key and the decryption key may be the same.). In some embodiments the encryption and decryption keys are stored in a database and associated with a particular user, user computer 102 and/or storage device 104. As described elsewhere herein, with both the encrypted password and the decryption key present in the decryption module 109, the decryption module 109 algorithmically decrypts the encrypted password to derive the data password.

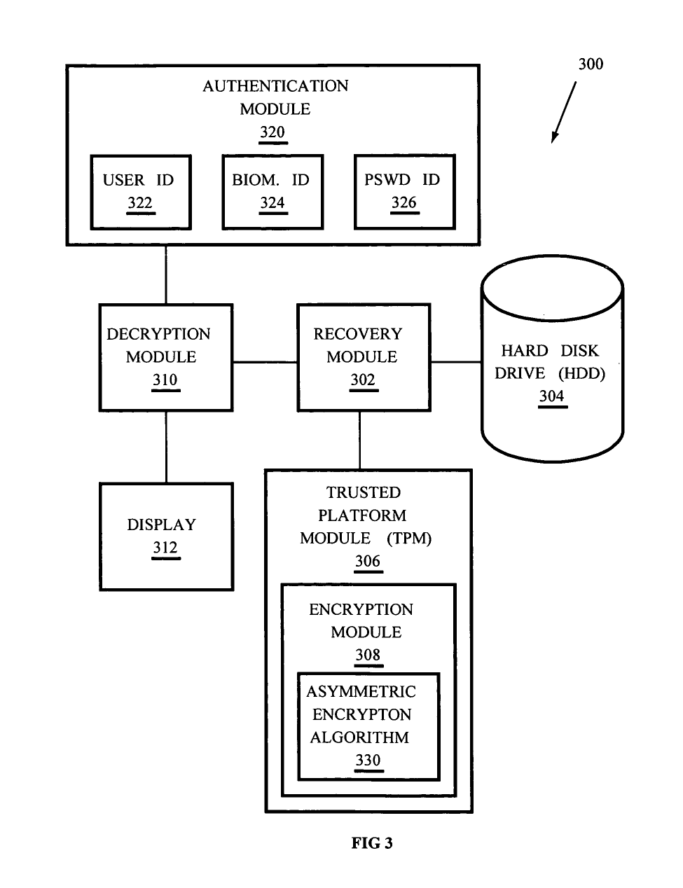

In several embodiments, the computer network 110 having PXE functionality transmits the encryption key from the secure computer 108 through the computer network 110 to the user computer 102. The user computer 102 stores the encryption key into the secure storage device 106 under control of BIOS software running in the user computer 102. The encryption module uses the encryption key in the secure storage device 106 to encrypt a data password to form an encrypted password for storage on the HDD 104 as is described in more detail with regard to FIGS. 3-7.

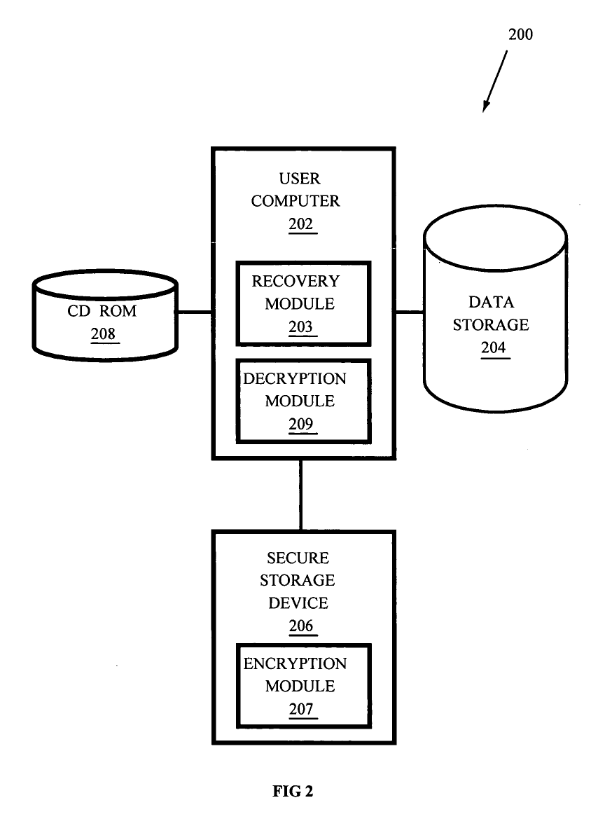

Referring to FIG. 2, there is shown some alternative embodiments of a password and data recovery system 200 having a user computer 202. In this and other embodiments, the user computer 202 is a stand alone computer. The user computer 202 can be a laptop computer, desktop personal computer, a server, or any other kind of computing device having a central processing unit (CPU). The user computer 202 includes a password recovery software module (recovery module) 203. In some embodiments, the recovery module 203 is communicatively coupled with, or functionally combined with, a basic input/output system (BIOS) program running on the user computer 202. The user computer 202 is communicatively coupled with a hard disk drive (HDD) 204 for mass non-volatile data storage. The HDD 204 can be integrated into the physical housing of the user computer 202 such as is normally the situation with a laptop or desktop computer, but this is not required. Furthermore, embodiments are not limited to the use of HDDs, but will function with any data storage device employed with the user computer 202 capable of containing password-protected data.

In the embodiment shown in FIG. 2, the user computer 202 is communicatively coupled with a non-volatile, secure, storage device (secure storage device) 206 such as a Trusted Platform Module (TPM), which is known in the art, but any non-volatile, secure, storage apparatus will also suffice. The secure storage device 206 contains an encryption module 207 for storing at least one encryption key as described herein and using at least one encryption key to encrypt a data password. The secure storage device 206 is in communication with the BIOS program associated with the recovery module program 203 running in the user computer 202. The BIOS program is modified from currently known BIOS programs in ways described herein to facilitate embodiments of the present invention. The secure storage device 206 contains an encryption module 207 for holding an encryption key. The secure storage device 206 employs the encryption key to encrypt the data password. Embodiments are not limited to any particular type of encryption and depending on the type of encryption, more than one encryption key can be used. In some alternative embodiments the encryption module 207 in the secure storage device 206 receives the encryption key directly from a secure computer maintained by the user computer manufacturer, user computer vendor or corporate IT personnel, without the use of a CD ROM drive 208.

In some embodiments, a CD ROM inserted into the CD ROM drive 208 contains the encryption and decryption keys. The CD ROM drive 208 transmits the encryption key to the BIOS associated with the recovery module 203 in the user computer 202, which stores the encryption key into the secure storage device 206 under control of the BIOS software in the user computer 202. The encryption key in the secure storage device 206 can encrypt a data password for storage on the HDD 204 as is described in more detail with regard to FIGS. 3-7. The encrypted password is passed to the recovery module 203 and stored in data storage 204. When the data password becomes lost, forgotten or otherwise unavailable, the recovery module 203 retrieves the encrypted password from data storage 204 and passes the encrypted password to a decryption module 209 in the user computer 202. The decryption module 209 obtains a copy of the decryption key from the CD ROM in the CD ROM drive 208 and decrypts the encrypted password to derive the data password. The data password is then displayed to the user to enable the user to access the otherwise inaccessible data in data storage 204

Referring to FIG. 3, there is shown a block diagram of a password recovery apparatus 300 according to some embodiments. The password recovery apparatus 300 includes a recovery module 302, a hard disk drive (HDD) 304, a trusted platform module (TPM) 306, a decryption module 310, a display 312 and an authentication module 320. The recovery module 302 is communicatively coupled with the hard disk drive 304. In other embodiments the recovery module 302 is communicatively coupled with data storage 104, 204, as shown in FIG. 1 and FIG. 2. The recovery module 302 causes both storage and retrieval of an encrypted data password from the HDD 304 to facilitate recovery of a data password that has become lost, forgotten or otherwise unavailable. The recovery module 302 is also communicatively coupled with the trusted platform module (TPM) 306. In other embodiments the recovery module 302 is communicatively coupled with the non-volatile storage device 106, 206, as shown in FIG. 1 and FIG. 2.

The TPM 306 includes an encryption module 308 to encrypt the data password. In some embodiments, the encryption module 308 employs an asymmetric encryption algorithm 330 with a public encryption key to encrypt the data password. The TPM 306 transmits the encrypted data password to the recovery module 302. The recovery module 302 stores the encrypted data password on the HDD 304. When prompted by the user or others as described herein, the recovery module 302 retrieves the encrypted password from the HDD 304. In some embodiments an identify device command is used to retrieve the encrypted data password.

Once the recovery module 302 has the encrypted password back from the HDD 304, the recovery module 302 transmits the encrypted password to the decryption module 310. The decryption module 310 has a copy of the decryption key used decrypt the data password. As described elsewhere herein, with the encrypted password and the decryption key present in the decryption module 310, the decryption module 310 algorithmically decrypts the encrypted password to derive the data password. In some embodiments, the data password is transmitted to the display 312 after authentication is confirmed with the authentication module 320. The display 312 provides an authenticated user with a visual indication of what the data password is. In other embodiments, the data password is transmitted to a display 312 without confirmation of authentication from the authentication module 320 because the user is self-authenticated, such as in the case of a stand alone PC. Self-authentication is supported because the user had original possession of the CD ROM containing the decryption key which correlates to subsequent possession of the CD ROM for password recovery.

Authentication of the user is performed in the authentication module 320 in conjunction with input from a person requesting the data password and/or access to the password-protected data. Various forms and combinations of authentication can be employed such as user identification 322, biometric identification 324 and/or user password identification 326. In authentication employing user identification 322, the user is asked to show a form of identification such as a driver's license. In authentication employing biometric identification, a biometric measurement is taken and compared against a database entry for that person, for example, a retina scan is taken for this purpose. In authentication using a password identification, a separate password is sought. For example, the person seeking access may need to know the user's mother's maiden name, etc. In further embodiments, a corporate IT person is shown the data password in addition to, or instead of, the user. In other embodiments the data password is not displayed, e.g., on display 312.

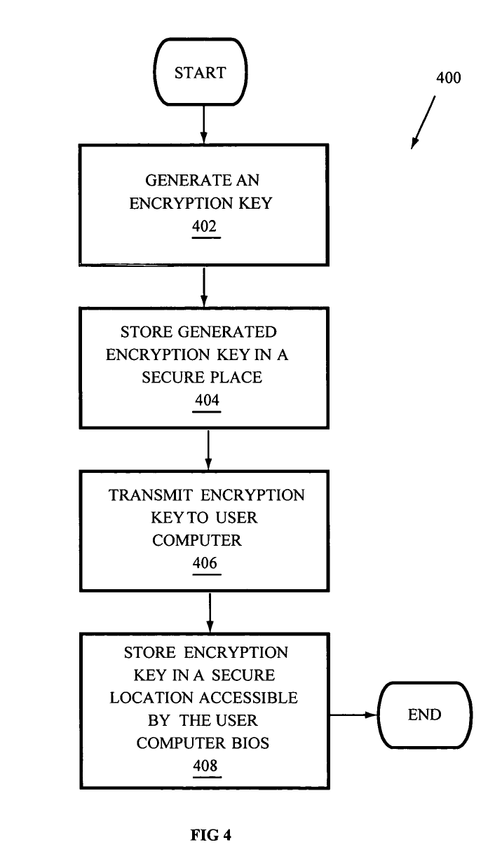

Referring to FIG. 4, there is shown an example of a flow chart 400 for the generation and storage of an encryption key. Flow chart 400 begins at block 402 with the generation of an encryption key. The encryption key can be generated by the user computer manufacturer, user computer vendor, authorized IT personnel, at a website on the Internet or by others. In one embodiment, the encryption key transmitted to the user computer 102, 202 is a public key portion of a public key/private key asymmetrical encryption algorithm. Symmetric key encryption algorithms and many other encryption algorithms exist, which are also used in some embodiments. Embodiments are not limited to any particular encryption algorithms and contemplate the use of any available encryption algorithm.

Continuing to block 404 from block 402, the encryption key is stored in a secure place. In FIG. 1, copies of the encryption and decryption keys are kept in, or associated with, the secure computer 108. In FIG. 2, copies of the encryption and decryption keys are stored on the CD ROM. Continuing to block 406 from block 404, the encryption key is transmitted to the user computer 102, 202. In FIG. 1 the encryption key can be transmitted from the secure computer 108 via the computer network 110 having a PXE capability to the user computer 102, but PXE is not required. Alternatively, the encryption key can be loaded into the user computer 102 by a user computer manufacturer, a user computer vendor, authorized IT personnel, or from a website on the Internet or by others. Embodiments are not limited to any particular method of transmitting the encryption key to the user computer 102. Irrespective of how the encryption key is transmitted to the user computer, in some embodiments a copy of the decryption key is kept in or associated with the secure computer for later decryption as is described herein. Alternatively, in FIG. 2, the encryption key is stored on a CD ROM. The CD ROM is inserted into the CD ROM drive 208 and the encryption key is transmitted from the CD ROM through the CD ROM drive 208 to the non-volatile secure storage device 206 in the user computer 202.

Continuing to block 408 from block 406, the encryption key received by the user computer 102, 202, is stored by the BIOS into a secure location accessible by the BIOS. Preferably, the secure location is only accessibly to the BIOS, but less secure locations suffice in some alternative embodiments. In FIG. 1 and FIG. 2 the encryption key is stored into the non-volatile secure storage device 106, 206, respectively. The BIOS is modified to be capable of storing the encryption key in the non-volatile secure storage device 106, 206. Flow chart 400 terminates at block 408.

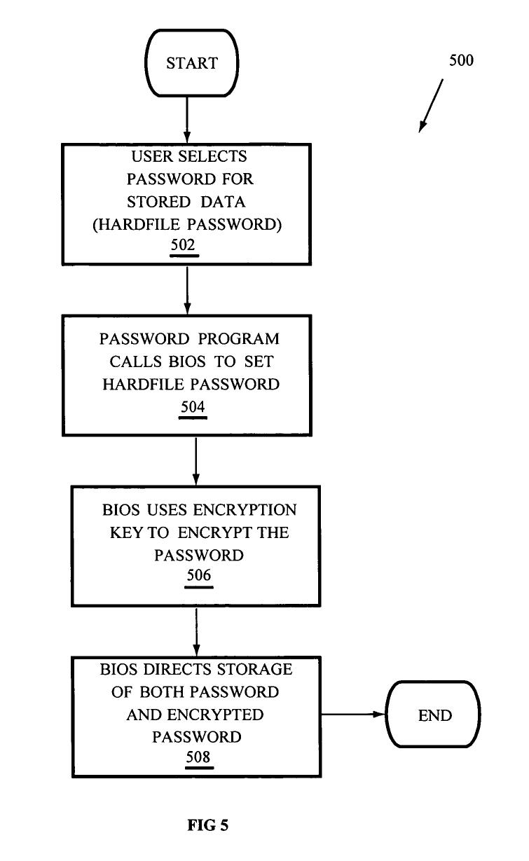

Referring to FIG. 5, there is shown an example of a flow chart 500 for the creation and storage of an encrypted password on the HDD 104, 204. Flow chart 500 begins at block 502 with a user selecting a data password for data stored in a hardfile on the HDD 104, 204. Embodiments are not limited to any particular method of generating the data password and also contemplate other ways of creating the password, such as employing computer-generated passwords and passwords specified by someone other than the user. Continuing to block 504 from block 502, a password program calls the BIOS to set the hardfile password on the HDD 104, 204. Continuing to block 506 from block 504, the BIOS, in conjunction with the non-volatile secure storage device 106, 206, uses the encryption key to encrypt the password. In some embodiments the encryption module 107, 207, receives the password and encrypts the password with the encryption key stored in the secure storage device (106, 206) and passes the encrypted password back to the BIOS. In alternative embodiments the BIOS retrieves the encryption key from non-volatile storage and initiates an encryption algorithm to encrypt the data password.

Continuing to block 508 from block 506, the BIOS in the user computer 102, 202, directs both the unencrypted and encrypted data passwords to be stored on the HDD 104, 204. The unencrypted or original data password is stored with the hardfile on the HDD 104, 204 to control access to the hardfile by the user having the password as has been done prior to the present invention. According to some embodiments, the encrypted password is stored into an area of the HDD 104, 204 responsive to the Identify Device command, i.e., when invoked, the Identify Device command will return the encrypted password to the user computer 102, 202. This is particularly useful when access to all or part of the HDD is otherwise prevented, e.g., when too many attempts to access the password-protected hardfiles with incorrect password(s) have occurred or if the password is lost, forgotten, etc. . . . Flow chart 500 terminates at block 508.

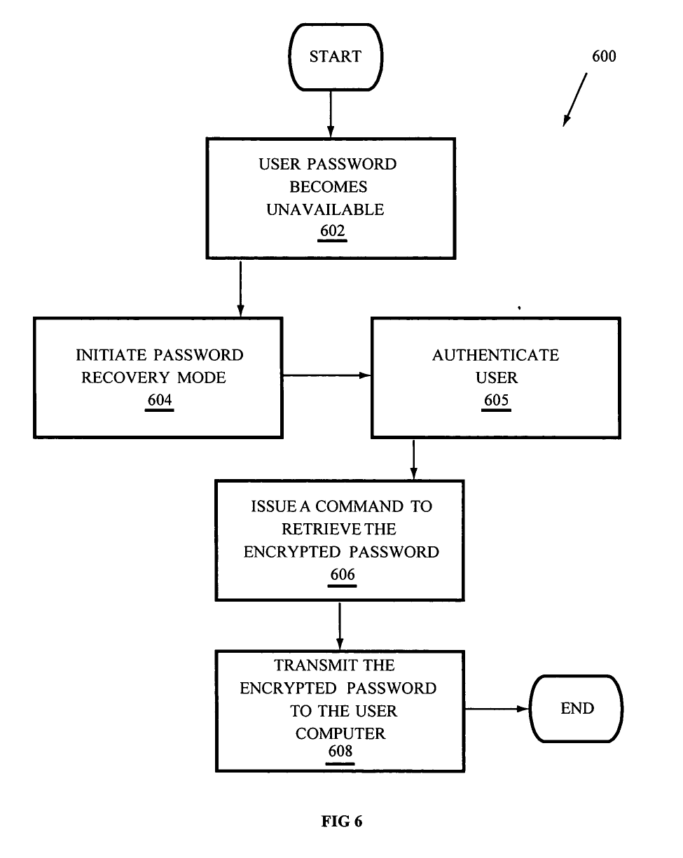

Referring to FIG. 6, there is shown an example of a flow chart 600 for accessing an encrypted password on the HDD 104, 204. Flow chart 600 begins at block 602 with the data password becoming lost, forgotten, or otherwise unavailable. When this occurs, for example, in FIG. 1 in a corporate setting, corporate personnel can confirm that the person claiming to have forgotten their password is who that person claims to be. This user authentication can include checking various identifications of the person, asking questions that only that person at the corporation is likely to know, biometric identification, use of a separate username and/or password, etc. In some embodiments, a database is employed as part of the secure computer to match user information to a particular computer to facilitate authentication of that user requesting recovery of their data password. In other situations the user may be uncooperative as in the case of a reduction in force (RIF) or may be no longer available for a variety of reasons included death or disablement. In FIG. 2, there is no separate authentication because the computer user controls the standalone computer, e.g., the computer user is the owner of the computer.

Continuing to block 604 from block 602, password recovery mode is initiated. In some of the embodiments illustrated by FIG. 1, the password recovery mode is initiated by the user and transmitted to those maintaining the secure computer 108, such as a corporate IT department or others as described above. In some embodiments, a PXE boot program is initiated under password recovery mode to retrieve the encrypted password. In some of the embodiments illustrated by FIG. 2, the computer user is responsible for initiating password recovery mode. In other embodiments, password recovery mode can be entered automatically, e.g., when password authentication has failed a certain number of times, e.g. four times.

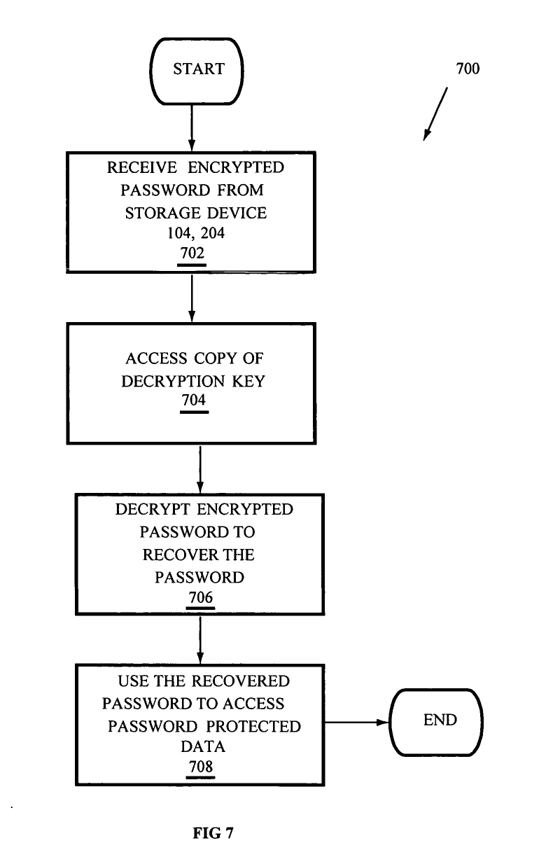

Continuing from block 604 to block 605, the user is authenticated. Embodiments employ one or more methods to authenticate a user. For example, user identification, e.g., a driver's license, biometric identification, e.g., a retina scan, and/or password identification, e.g., mother's maiden name, are used to authenticate a user as described with respect to FIG. 3. Continuing to block 606 from block 605, once password recovery mode is initiated in block 604, a command is issued to retrieve the encrypted password from the storage device 104, 204, such as a hard disk drive. In some embodiments, the command is an Identify Device command, alternatively, other commands that can retrieve data from the storage device 104, 204 can be used. Preferably, such commands can retrieve data from the storage device 104, 204 even if the storage device is otherwise locked, e.g., if the user tried an improper password or passwords too many times, e.g., five times. Continuing to block 608 from block 606, in response to the command to retrieve the encrypted password, the storage device 104, 204 transmits the encrypted password to the user computer 102, 202. In some alternative embodiments the HDD 104, 204 may be physically removed from communication with user computer 102, 202 so that the encrypted password is passed directly to another computer, e.g., the secure computer 108, 208, and processed as described in FIG. 7.

Referring to FIG. 7, there is shown an example of a flow chart 700 for decrypting the encrypted password to recover the data password and correspondingly recover the password-protected data in the user computers 102, 202 illustrated in FIG. 1 and FIG. 2. Flow chart 700 begins at block 702 with receiving the encrypted password from the storage device 104, 204 as shown and described with regard to FIG. 6. With respect to FIG. 1, the encrypted password is received from the HDD 104 via the BIOS in the user computer 102 and retransmitted through the computer network 110 to the secure computer 108. With respect to FIG. 2, the encrypted password is received from the HDD 204 via the BIOS in the user computer 202 and held in the user computer 202 without being retransmitted as in FIG. 1. Regarding the BIOS, the BIOS used in some embodiments has capabilities to either encrypt the data password or initiate encryption of the data password, cause the storage of both the data password and encrypted password on the storage device 104, 204, retrieve or cause the retrieval of the encrypted password, and in some embodiments decrypt the encrypted password. Continuing to block 704 from block 702, a copy of the decryption key is retrieved. In FIG. 1, the secure computer 108 accesses the stored decryption key associated with the user, the user computer 102 and/or its HDD 104. Note that the embodiments are not limited by the level of security associated with the secure computer 108, which in the absolute sense may not be secure, but in FIG. 1 the secure computer 108 is secure at least in the sense that it is a different computer than the user computer 102 in FIG. 1. In FIG. 2 the stand alone user computer retrieves the decryption key from the CD ROM used in FIG. 3 and described herein. In other alternative embodiments the decryption key resident in the secure storage device 106, 206 can be used.

Having completed blocks 702 and 704 in FIG. 7, both the encrypted password and the decryption key used to decrypt the encrypted password have been retrieved. Continuing to block 706 from block 704, the encrypted password is decrypted with a copy of the decryption key to recover a copy of the original password used to password-protect data on the HDD 104, 204. As described above, the embodiments are not limited to a particular form of encryption/decryption and more than one key can be used. Decryption is known in the relevant arts and the proper key or keys and the encrypted password are used to algorithmically process the encrypted password to effectuate decryption of the data password.

The recovered password can be used to recover the password-protected data (block 708). In FIG. 1 the recovered password can be provided to the authenticated user directly. This would allow the user to not only access the password-protected data in the hardfile, but if the password is used elsewhere by the user, having the password again may help the user to access other resources legitimately available to the user. In some embodiments, if desired, before the recovered password is displayed on the secure computer 108 a warning that only the user should be shown the next screen can be issued. The screen containing the recovered data password is displayed to the user and the user directed to click on an icon button to erase the screen. In this fashion only the authenticated user is provided with the user's recovered data password. In further embodiments, the operator of the secure computer 108 can become aware of the password or use the password to unlock the protected data, with or without the further assistance of the user. In several embodiments, the PXE-enabled computer network 110 in combination with the secure computer 108 use the recovered data password to unlock the protected data for the user. In FIG. 2, the user computer displays the password to the user who is free to act with the recovered data password, however a warning screen can relate to the user that their password is about to be displayed and they may wish to take certain precautions before the display is activated.

Some embodiments of the invention are implemented as a program product for use with a computer system such as, for example, the system 100 shown in FIG. 1. The program product could be used on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates systems and methods to access password-protected stored data when the associated data password has become lost, forgotten, or is otherwise unavailable, and to recover the data password and data protected by the password from a digital memory device such as a hard disk drive. It is understood that the forms of the invention shown and described in the detailed description and the drawings are to be taken merely as examples. It is intended that the following claims be interpreted broadly to embrace all the variations of the example embodiments disclosed herein.

What is claimed is:

1. A method for recovering a data password stored in a data storage device, comprising:
storing the data password on the data storage device;
encrypting the data password to form an encrypted password;
storing the encrypted password on the data storage device;
recovering the encrypted password from the data storage device; and
decrypting the encrypted password to derive the data password.

2. The method of claim 1, further comprising authenticating a user prior to providing the user with the data password.

3. The method of claim 1, wherein encrypting comprises requesting a user to create the data password.

4. The method of claim 1, wherein encrypting comprises creating the data password with a computer program.

5. The method of claim 1, wherein encrypting the data password comprises encrypting the data password with at least one encryption key.

6. The method of claim 1, wherein encrypting the data password comprises encrypting the data password with an asymmetrical encryption algorithm.

7. The method of claim 1, wherein recovering the encrypted password comprises requesting a user to provide the data password and receiving an indication that the user failed to provide the data password.

8. The method of claim 1, wherein recovering the encrypted password from the data storage device comprises executing a command to retrieve the encrypted password.

9. The method of claim 1, wherein decrypting the encrypted password to derive the data password comprises transmitting the encrypted password to another computer to perform a decryption algorithm.

10. An apparatus for recovering a data password, comprising:
an encryption module to encrypt the data password to form the encrypted password;
a data storage device to store the data password and the encrypted password received from the encryption module;
a recovery module to retrieve the encrypted password from the data storage device; and
a decryption module to receive the encrypted password from the recovery module and to decrypt the encrypted password to derive the data password.

11. The apparatus of claim 10, further comprising an authentication module to authenticate a user prior to providing the user with the data password received from the decryption module.

12. The apparatus of claim 10, wherein the encryption module is part of a non-volatile storage device.

13. The apparatus of claim 12, wherein the non-volatile storage device is a trusted platform module.

14. The apparatus of claim 12, wherein at least one encryption key is stored in the non-volatile storage device.

15. The apparatus of claim 14, wherein the at least one encryption key is accessible to a BIOS program communicatively coupled with the recovery module.

16. The apparatus of claim 10, wherein the data storage device is a hard disk drive.

17. The apparatus of claim 16, wherein the hard disk drive is part of a stand alone desktop personal computer.

18. The apparatus of claim 10, wherein the recovery module is part of a personal computer and the decryption module is part of another computer.

19. The apparatus of claim 10, wherein the recovery module and the decryption module are both parts of a personal computer.

20. A method for recovering a data password used to password-protect data, comprising:
receiving the data password with a computer, the computer being communicatively coupled with a hard disk drive;
receiving an encryption key with the computer;
storing the encryption key in a non-volatile memory in the computer;
encrypting the data password with the computer to form an encrypted password;
storing the data password and the encrypted password on the hard disk drive;
recovering the encrypted password from the hard disk drive; and
decrypting the encrypted password to derive the data password.

21. The method of claim 20, further comprising authenticating a user prior to providing the user with the data password.

22. The method of claim 20, wherein receiving an encryption key with the computer comprises receiving the encryption key via a computer network.

23. The method of claim 22, wherein the computer network has a Preboot execution Environment (PXE) capability.

24. The method of claim 20, wherein receiving the encryption key with the computer comprises receiving the encryption key from a removable, non-volatile media.

25. The method of claim 20, wherein recovering the encrypted password from the hard disk drive comprises using an identify device command to retrieve the encrypted password.

26. A computer-readable medium containing instructions for recovering a data password used to password-protect data, which, when executed by a computer, cause said computer to perform operations, comprising:
storing the data password on a data storage device;
encrypting the data password to form an encrypted password;
storing the encrypted password on the data storage device;
recovering the encrypted password from the data storage device; and
decrypting the encrypted password to derive the data password.

27. The method of claim 26, further comprising authenticating a user prior to providing the user with the data password.

28. The method of claim 26, further comprising requesting a user to provide the data password.

29. The method of claim 26, further comprising creating the data password with a computer program.
